(19) United States
(12) Patent Application Publication
(10) Pub. No.: US 2025/0078551 A1
(43) Pub. Date: Mar. 6, 2025

(54) Data Processing Method and Apparatus

(71) Applicants: Beijing Wodong Tianjun Information Technology Co., Ltd., Beijing (CN); Beijing Jingdong Century Trading Co., Ltd., Beijing (CN)

(72) Inventor: Juan Zhang, Beijing (CN)

(73) Assignees: Beijing Wodong Tianjun Information Technology Co., Ltd., Beijing (CN); Beijing Jingdong Century Trading Co., Ltd., Beijing (CN)

(21) Appl. No.: 18/252,647

(22) PCT Filed: Oct. 22, 2021
(86) PCT No.: PCT/CN2021/125721

§ 371 Date: May 11, 2023

(30) Foreign Application Priority Data
Nov. 12, 2020 (CN) 202011261210.8

(51) Int. Cl. G06V 30/19; G06V 30/148; G06V 30/413; G06V 30/414; G06V 30/416

(52) U.S. Cl. CPC G06V 30/19147; G06V 30/158; G06V 30/413; G06V 30/414; G06V 30/416

(57) ABSTRACT

Disclosed are a data processing method and apparatus. The method includes: annotating, in response to receiving a page image, the page image to generate image sets corresponding to annotated data, the image sets including a first image set for recognizing a container type, a second image set for recognizing text information, and a third image set for detecting an image element; inputting the image sets into a trained image recognition model to generate a container type data set corresponding to the first image set, a text data set corresponding to the second image set and an image element data set corresponding to the third image set; performing a conversion on the container type data set, the text data set and the image element data set based on template information of a page to generate a template data set corresponding to the page image, and uploading the template data set.

This patent application is a National Stage of International Application No. PCT/CN2021/125721, filed Oct. 22, 2021, which claims the priority from Chinese Patent Application No. 202011261210.8, filed on Nov. 12, 2020 and entitled “Method and Apparatus for Processing Data,” the entire disclosures of which are hereby incorporated by reference.

### FIELD

Embodiments of the present disclosure relate to the field of computer technology, specifically to the field of image recognition technology, and particularly to a method and apparatus for processing data.

### BACKGROUND

With the rapid development of networks, it is becoming more and more common for people to interactively visit various websites by browsing webpages, and therefore, the requirements for page building are getting higher and higher.

### SUMMARY

The present disclosure provides a method and apparatus for processing data, a device and a storage medium.

According to a first aspect of the present disclosure, a method for processing data is provided. The method includes: annotating, in response to receiving a page image, the page image to generate image sets corresponding to annotated data, where the image sets include a first image set for recognizing a container type, a second image set for recognizing text information, and a third image set for detecting an image element, and the page image is generated based on a page template; inputting the image sets into a trained image recognition model to generate a container type data set corresponding to the first image set, a text data set corresponding to the second image set and an image element data set corresponding to the third image set, where the image recognition model is used to represent a container type determination for each image in the first image set, a word detection and text recognition for each image in the second image set and an image element detection and recognition for each image in the third image set; and performing a conversion on the container type data set, the text data set and the image element data set based on template information of a page to generate a template data set corresponding to the page image, and uploading the template data set, where the conversion is performed on the container type data set, the text data set and the image element data set based on a specific language structure.

In some embodiments, annotating the page image to generate the image sets corresponding to the annotated data includes: annotating the page image to obtain the annotated data corresponding to the page image; inputting the annotated data into a position determination model to generate position information of each block corresponding to the annotated data, where the position determination model is trained and obtained through historical related data of the annotated data; and determining the image sets corresponding to the annotated data based on the position information of each block.

In some embodiments, the image recognition model is trained and obtained by: acquiring a training sample set, where a training sample in the training sample set includes the first image set for recognizing the container type, the second image set for recognizing the text information, the third image set for detecting the image element, the container type data set corresponding to the first image set, the text data set corresponding to the second image set and the image element data set corresponding to the third image set; and using a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data.

In some embodiments, the image recognition model includes a container type recognition sub-model, a text recognition sub-model and an element recognition sub-model, and inputting the image sets into the trained image recognition model to generate the container type data set corresponding to the first image set, the text data set corresponding to the second image set and the image element data set corresponding to the third image set includes: inputting the first image set into the container type recognition sub-model to generate the container type data set corresponding to the first image set, where the container type recognition sub-model is used to represent the container type determination for each image in the first image set; inputting the second image set into the text recognition sub-model to generate the text data set corresponding to the second image set, where the text recognition sub-model is used to represent the word detection and text recognition for each image in the second image set; and inputting the third image set into the element recognition sub-model to generate the image element data set corresponding to the third image set, where the element recognition sub-model is used to represent the image element detection and recognition for each image in the third image set.

In some embodiments, the text recognition sub-model includes a feature extraction sub-model and a word sequence extraction sub-model, and inputting the second image set into the text recognition sub-model to generate the text data set corresponding to the second image set includes: inputting the second image set into the feature extraction sub-model to obtain each feature matrix corresponding to the second image set, where the feature extraction sub-model is constructed based on a convolutional neural network; inputting each feature matrix into the word sequence extraction sub-model to obtain a word sequence corresponding to each feature matrix, where the word sequence extraction sub-model is constructed based on a recursive neural network; and determining, based on each word sequence, text information corresponding to each word sequence, and generating the text data set corresponding to each piece of text information.

In some embodiments, the image recognition model is constructed based on a deep residual network model, and/or the container type recognition sub-model is constructed based on the deep residual network model.

In some embodiments, before performing the conversion on the container type data set, the text data set and the image element data set based on template information of the page to generate the template data set corresponding to the page image, the method further includes: performing a correction on the container type data set, the text data set and the image element data set to obtain corrected container type data set, corrected text data set and corrected image element data set, where the correction is used to represent reordering data in the container type data set, the text data set and the image element data set based on an analysis result of an image position, image order and image repeatability of each image in the image sets.

In some embodiments, the correction is accomplished based on a combination of image scaling, image graying, an image enhancement, an image noise reduction and an image edge detection on each image in the image sets.

In some embodiments, before performing the correction on the container type data set, the text data set and the image element data set to obtain the corrected container type data set, the corrected text data set and the corrected image element data set, the method further includes: performing content recognition on the image sets to obtain a first data set corresponding to the first image set, a second data set corresponding to the second image set and a third data set corresponding to the third image set; and performing a revision on the data in the container type data set, the text data set and the image element data set according to a comparison result of the first data set, the second data set and the third data set with the container type data set, the text data set and the image element data set, to obtain revised container type data set, revised text data set and revised image element data set.

In some embodiments, the method further includes: generating a template interface corresponding to the template data set based on the template data set, and presenting the template interface; and/or optimizing a design scheme of the page template based on the template data set.

According to a second aspect of the present disclosure, an apparatus for processing data is provided. The apparatus includes: an annotating unit, configured to annotate, in response to receiving a page image, the page image to generate image sets corresponding to annotated data, where the image sets include a first image set for recognizing a container type, a second image set for recognizing text information, and a third image set for detecting an image element, and the page image is generated based on a page template; a generating unit, configured to input the image sets into a trained image recognition model to generate a container type data set corresponding to the first image set, a text data set corresponding to the second image set and an image element data set corresponding to the third image set, where the image recognition model is used to represent a container type determination for each image in the first image set, a word detection and text recognition for each image in the second image set and an image element detection and recognition for each image in the third image set; and a converting unit, configured to perform a conversion on the container type data set, the text data set and the image element data set based on template information of a page to generate a template data set corresponding to the page image, and upload the template data set, where the conversion is performed on the container type data set, the text data set and the image element data set based on a specific language structure.

In some embodiments, the annotating unit includes: an annotating module, configured to annotate the page image to obtain the annotated data corresponding to the page image; a position generating module, configured to input the annotated data into a position determination model to generate position information of each block corresponding to the annotated data, where the position determination model is trained and obtained through historical related data of the annotated data; and a determining module, configured to determine the image sets corresponding to the annotated data based on the position information of each block.

In some embodiments, the image recognition model in the generating unit is trained and obtained using: an acquiring module, configured to acquire a training sample set, where a training sample in the training sample set includes the first image set for recognizing the container type, the second image set for recognizing the text information, the third image set for detecting the image element, the container type data set corresponding to the first image set, the text data set corresponding to the second image set and the image element data set corresponding to the third image set; and a training module, configured to use a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data.

In some embodiments, the image recognition model in the generating unit includes a container type recognition sub-model, a text recognition sub-model and an element recognition sub-model, and the generating unit includes: a first generating module, configured to input the first image set into the container type recognition sub-model to generate the container type data set corresponding to the first image set, where the container type recognition sub-model is used to represent the container type determination for each image in the first image set; a second generating module, configured to input the second image set into the text recognition sub-model to generate the text data set corresponding to the second image set, where the text recognition sub-model is used to represent the word detection and text recognition for each image in the second image set; and a third generating module, configured to input the third image set into the element recognition sub-model to generate the image element data set corresponding to the third image set, where the element recognition sub-model is used to represent the image element detection and recognition for each image in the third image set.

In some embodiments, the text recognition sub-model in the second generating module includes a feature extraction sub-model and a word sequence extraction sub-model, and the second generating module includes: a feature extraction sub-module, configured to input the second image set into the feature extraction sub-model to obtain each feature matrix corresponding to the second image set, where the feature extraction sub-model is constructed based on a convolutional neural network; a word extraction sub-module, configured to input each feature matrix into the word sequence extraction sub-model to obtain a word sequence corresponding to each feature matrix, where the word sequence extraction sub-model is constructed based on a recursive neural network; and a determining sub-module, configured to determine, based on each word sequence, text information corresponding to each word sequence, and generate the text data set corresponding to each piece of text information.

In some embodiments, the image recognition model in the generating unit is constructed based on a deep residual network model, and/or the container type recognition sub-model in the generating unit is constructed based on the deep residual network model.

In some embodiments, the apparatus further includes: a correcting unit, configured to perform a correction on the container type data set, the text data set and the image element data set to obtain corrected container type data set, corrected text data set and corrected image element data set, where the correction is used to represent reordering data in the container type data set, the text data set and the image element data set based on an analysis result of an image position, image order and image repeatability of each image in the image sets.

In some embodiments, the correction in the correcting unit is accomplished based on a combination of image scaling, image graying, an image enhancement, an image noise reduction and an image edge detection on each image in the image sets.

In some embodiments, the apparatus further includes: a recognizing unit, configured to perform content recognition on the image sets to obtain a first data set corresponding to the first image set, a second data set corresponding to the second image set and a third data set corresponding to the third image set; and a revising unit, configured to perform a revision on the data in the container type data set, the text data set and the image element data set according to a comparison result of the first data set, the second data set and the third data set with the container type data set, the text data set and the image element data set, to obtain revised container type data set, revised text data set and revised image element data set.

In some embodiments, the apparatus further includes: a presenting unit, configured to generate a template interface corresponding to the template data set based on the template data set, and present the template interface; and/or an optimizing unit, configured to optimize a design scheme of the page template based on the template data set.

According to a third aspect of the present disclosure, an electronic device is provided. The electronic device includes at least one processor; and a memory, in communication with the at least one processor. The memory stores instructions executable by the at least one processor, and the instructions when executed by the at least one processor, cause the at least one processor to perform the method according to any implementation in the first aspect.

According to a fourth aspect of the present disclosure, a non-transitory computer readable storage medium storing a computer instruction is provides. The computer instruction is used to cause a computer to perform the method according to any implementation in the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure.

FIG. 1 is a schematic diagram of a first embodiment of a method for processing data according to the present disclosure;

FIG. 2 is a diagram of a scenario where the method for processing data according to an embodiment of the present disclosure can be implemented;

FIG. 3 is a schematic diagram of a second embodiment of the method for processing data according to the present disclosure;

FIG. 4 is a schematic structural diagram of an embodiment of an apparatus for processing data according to the present disclosure; and

FIG. 5 is a block diagram of an electronic device used to implement the method for processing data according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

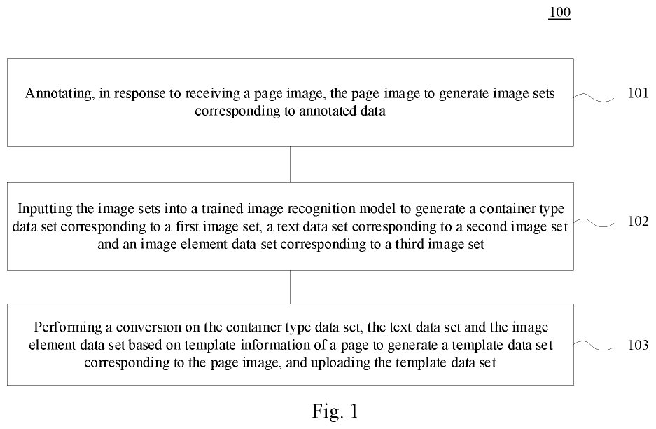

FIG. 1 is a schematic diagram 100 of a first embodiment of a method for processing data according to the present disclosure. The method for processing data includes following steps.

Step 101, annotating, in response to receiving a page image, the page image to generate image sets corresponding to annotated data.

In this embodiment, when receiving a page image by means of a wired connection or a wireless connection, an executing body (e.g., a server or an intelligent terminal) may annotate the page image by means of a page crawler to generate the image sets corresponding to the annotated data. The image sets may include: a first image set for recognizing a container type, a second image set for recognizing text information, and a third image set for detecting an image element. The page image may be generated based on a page template. The template may be generated based on the building of floors of a dynamic page. The image sets may be intersected with, contained in, or the same as each other. Since the template is a basic unit for building the dynamic page, the display for the floors of the dynamic page can be completed by configuring the template, and the same template can be used on the page many times. It should be noted that the above wireless connection may include, but not limited to, 3G, 4G and 5G connections, a WiFi connection, a Bluetooth connection, a WiMAX connection, a Zigbee connection, a UWB (ultra wideband) connection, and other wireless connections now known or developed in the future.

Step 102, inputting the image sets into a trained image recognition model to generate a container type data set corresponding to a first image set, a text data set corresponding to a second image set and an image element data set corresponding to a third image set.

In this embodiment, the executing body may input the image sets into the trained image recognition model to generate the container type data set corresponding to the first image set, the text data set corresponding to the second image set and the image element data set corresponding to the third image set. The image recognition model is used to represent a container type determination for each image in the first image set, a word detection and text recognition for each image in the second image set and an image element detection and recognition for each image in the third image set. The image recognition model is trained and obtained through the historical related data of the image sets.

In some alternative implementations, the image recognition model is trained and obtained by: acquiring a training sample set, where a training sample in the training sample set includes the first image set for recognizing the container type, the second image set for recognizing the text information, the third image set for detecting the image element, the container type data set corresponding to the first image set, the text data set corresponding to the second image set and the image element data set corresponding to the third image set; and using a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data. The training for the model is performed using the deep learning technology, which makes the prediction of the model more accurate and comprehensive.

Step 103, performing a conversion on the container type data set, the text data set and the image element data set based on template information of a page to generate a template data set corresponding to the page image, and uploading the template data set.

In this embodiment, the executing body may use a data conversion method to perform the conversion on the container type data set, the text data set and the image element data set based on the template information of the page to generate the template data set corresponding to the page image, and upload the template data set. The conversion is performed on the container type data set, the text data set and the image element data set based on a specific language structure. For example, the container type data set, the text data set and the image element data set are converted into a domain-specific language (DSL) to realize the normalization of the data. The normalized data is uploaded to the Content Delivery Network (CDN) for content storage, so as to perform an update and maintenance through a visual interface.

It should be noted that the technician can set the model structure of the image recognition model by himself according to actual requirements, which is not limited in the embodiments of the present disclosure.

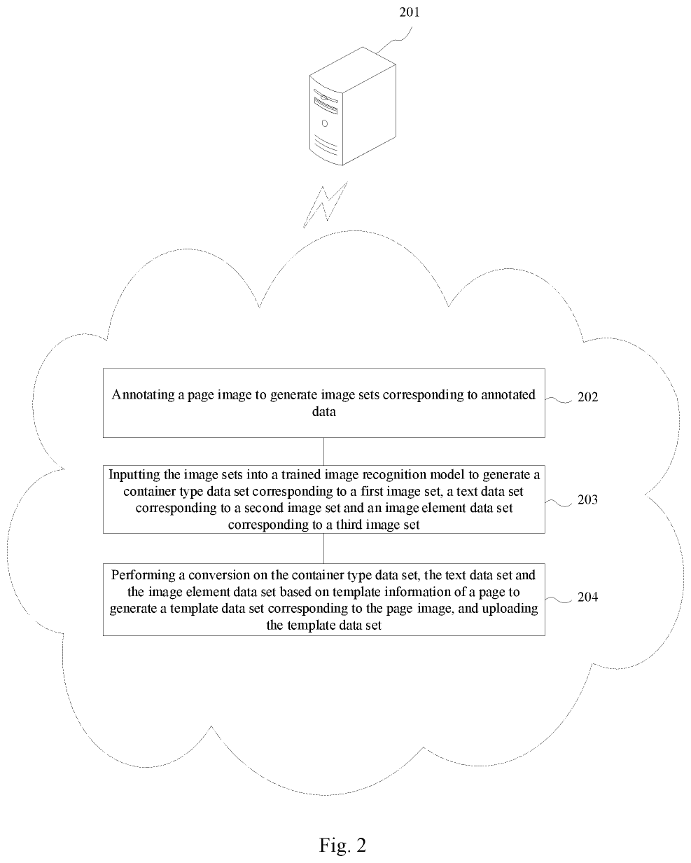

Further referring to FIG. 2, a method 200 for processing data in this embodiment runs in a service platform 201. After receiving a page image, the service platform 201 annotates the page image to generate image sets 202 corresponding to annotated data. Then, the service platform 201 inputs the image sets into a trained image recognition model to generate a container type data set corresponding to a first image set, a text data set corresponding to a second image set, and an image element data set 203 corresponding to a third image set. Next, the service platform 201 performs a conversion on the container type data set, the text data set and the image element data set based on template information of a page, to generate a template data set corresponding to the page image, and uploads the template data set 204. Here, the image sets include a first image set for recognizing a container type, a second image set for recognizing text information, and a third image set for detecting an image element. The page image is generated based on a page template. The image recognition model is used to represent a container type determination for each image in the first image set, a word detection and text recognition for each image in the second image set and an image element detection and recognition for each image in the third image set.

According to the method for processing data provided in the above embodiment of the present disclosure, in response to receiving the page image, the page image is annotated to generate the image sets corresponding to the annotated data. The image sets are inputted into the trained image recognition model to generate the container type data set corresponding to the first image set, the text data set corresponding to the second image set and the image element data set corresponding to the third image set. Here, the image recognition model is used to represent the container type determination for the each image in the first image set, the word detection and text recognition for the each image in the second image set and the image element detection and recognition for the each image in the third image set. The conversion is performed on the container type data set, the text data set and the image element data set based on the template information of the page to generate the template data set corresponding to the page image, and the template data set is uploaded. The page image is converted into template data by using the image recognition technology, and the template data is stored into a content distribution network by uploading the data, thereby avoiding the linear increment of the number of files due to the increasing demands for templates, and addressing the problems of poor reusability of JSON files in the existing technology and high maintenance cost during the building of pages. Accordingly, the precise positioning of the template data and the high efficiency in making the template on line are implemented, and both hands of a maintenance person are freed. The template data set is directly generated through the image recognition technology, which saves the development resources and maintenance cost of the system, and improves the flexibility of building the template.

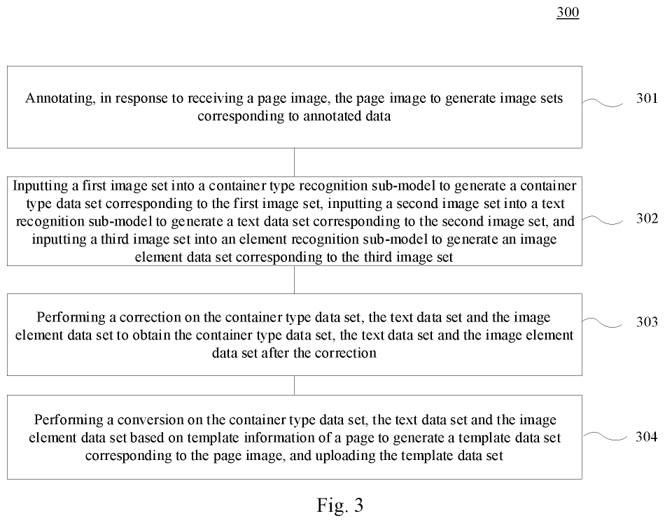

Further referring to FIG. 3, FIG. 3 is a schematic diagram 300 of a second embodiment of the method for processing data. The flow of the method includes following steps.

Step 301, annotating, in response to receiving a page image, the page image to generate image sets corresponding to annotated data.

In some alternative implementations of this embodiment, annotating the page image to generate the image sets corresponding to the annotated data includes: annotating the page image to obtain the annotated data corresponding to the page image; inputting the annotated data into a position determination model to generate position information of each block corresponding to the annotated data, the position determination model being trained and obtained through historical related data of the annotated data; and determining the image sets corresponding to the annotated data based on the position information of the each block. The position determination model may be to use the content analysis algorithm readability to calculate the most likely block position information according to the different weights of the annotated data. By using this method, the positioning of an effective block can achieve a more precise effect.

Step 302, inputting a first image set into a container type recognition sub-model to generate a container type data set corresponding to the first image set, inputting a second image set into a text recognition sub-model to generate a text data set corresponding to the second image set, and inputting a third image set into an element recognition sub-model to generate an image element data set corresponding to the third image set.

In this embodiment, an image recognition model may include a container type recognition sub-model, a text recognition sub-model, and an element recognition sub-model. An executing body may input the first image set into the container type recognition sub-model to generate the container type data set corresponding to the first image set, input the second image set into the text recognition sub-model to generate the text data set corresponding to the second image set, and input the third image set into the element recognition sub-model to generate the image element data set corresponding to the third image set. The container type recognition sub-model is used to represent a container type determination for each image in the first image set. The text recognition sub-model is used to represent a word detection and text recognition for each image in the second image set. The element recognition sub-model is used to represent an image element detection and recognition for each image in the third image set. The image recognition model and the container type recognition sub-model are constructed based on a deep residual network model. A deep residual network (ResNet) is used to address the problem of the apparent degradation of performance of the neural network due to the increase of the depth.

In some alternative implementations of this embodiment, the text recognition sub-model includes a feature extraction sub-model and a word sequence extraction sub-model. The inputting a second image set into a text recognition sub-model to generate a text data set corresponding to the second image set includes: inputting the second image set into the feature extraction sub-model to obtain each feature matrix corresponding to the second image set, where the feature extraction sub-model is constructed based on a convolutional neural network; inputting the each feature matrix into the word sequence extraction sub-model to obtain a word sequence corresponding to each feature matrix, where the word sequence extraction sub-model is constructed based on a recursive neural network; and determining, based on each word sequence, text information corresponding to the each word sequence, and generating the text data set corresponding to each piece of text information. During the text recognition, a convolutional neural network CNN algorithm is used to perform a feature extraction, minute changes in image rotation and local parts are overcome through a pooling operation, and then a prediction tag division is performed according to the recursive neural network RNN to model the changes in time series so as to transfer a serialized message. Finally, a sequence loss function (connectionist temporal classification, CTC loss) is used as a target function for optimization. As a loss function in the sequence annotation problem, the CTC loss is mainly used to deal with the input and output tag alignment problem in the sequence annotation problem.

Step 303, performing a correction on the container type data set, the text data set and the image element data set to obtain corrected container type data set, corrected text data set and corrected image element data set.

In this embodiment, the executing body may perform the correction on the container type data set, the text data set and the image element data set to obtain the corrected container type data set, the corrected text data set and the corrected image element data set. The correction is used to represent reordering the data in the container type data set, the text data set and the image element data set based on the analysis result of an image position, image order and image repeatability of each image in the image sets. By detecting and correcting the data after the positioning and recognition, the precision of the data is improved.

Further, for example, the executing body may measure an image element in the image sets based on a morphological transformation method to obtain the outline information of an element box; correct the outline information of the element box using a position correction method; align the corrected outline information of the element box, where the alignment represents an alignment for at least one of the abscissa of the element box or the ordinate of the element box; and reorder the aligned element box to obtain the ordered container type data set, the ordered text data set and the ordered image element data set.

In some alternative implementations of this embodiment, the correction is accomplished based on a combination of image scaling, image graying, an image enhancement, an image noise reduction and an image edge detection on each image in the image sets. It should be noted that the above image processing methods are well-known techniques widely studied and applied at present, and thus will not be repeatedly described here. The use of a combination of correction formulas and the setting of parameters are achieved by developers through practice, which improves the efficiency and precision of the system.

In some alternative implementations of this embodiment, before performing the correction on the container type data set, the text data set and the image element data set to obtain the corrected container type data set, the corrected text data set and the corrected image element data set, the method further includes: performing content recognition on the image sets through a content recognition method to obtain a first data set corresponding to the first image set, a second data set corresponding to the second image set and a third data set corresponding to the third image set; and performing a revision on the data in the container type data set, the text data set and the image element data set according to a comparison result of the first data set, the second data set and the third data set with the container type data set, the text data set and the image element data set, to obtain revised container type data set, revised text data set and revised image element data set. After a traditional image processing result is acquired, a number of revisions are performed on the data by combining a deep detection result and the traditional image processing result, thereby improving the precision of the data.

Step 304, performing a conversion on the container type data set, the text data set and the image element data set based on template information of a page to generate a template data set corresponding to the page image, and uploading the template data set.

In some alternative implementations of this embodiment, the method further includes: generating a template interface corresponding to the template data set based on the template data set, and presenting the template interface. A cross-front-end application that builds quickly and flexibly active templates is realized.

In some alternative implementations of this embodiment, the method further includes: optimizing a design scheme of a page template based on the template data set. An on-line template generation configuration capability of mixing and combining template styles and template data is achieved, and the capability of providing a better template scheme to the existing on-line page is achieved, thereby further improving the commodity conversion rate.

In this embodiment, the specific operations of steps 301 and 304 are substantially the same as those of steps 101 and 103 in the embodiment shown in FIG. 1, and thus will not be repeatedly described here.

It can be seen from FIG. 3 that, as compared with the embodiment corresponding to FIG. 1, according to the schematic diagram 300 of the method for processing data in this embodiment, the first image set is inputted into the container type recognition sub-model to generate the container type data set corresponding to the first image set, the second image set is inputted into the text recognition sub-model to generate the text data set corresponding to the second image set, the third image set is inputted into the element recognition sub-model to generate the image element data set corresponding to the third image set, and the correction is performed on the container type data set, the text data set and the image element data set to obtain the corrected container type data set, the corrected text data set and the corrected image element data set. The container type data set, the text data set and the image element data set are respectively obtained based on different models, making the processing for the data more precise and targeted. The residual network design model is used to solve the gradient vanishing problem of the model, which improves the precision of model training.

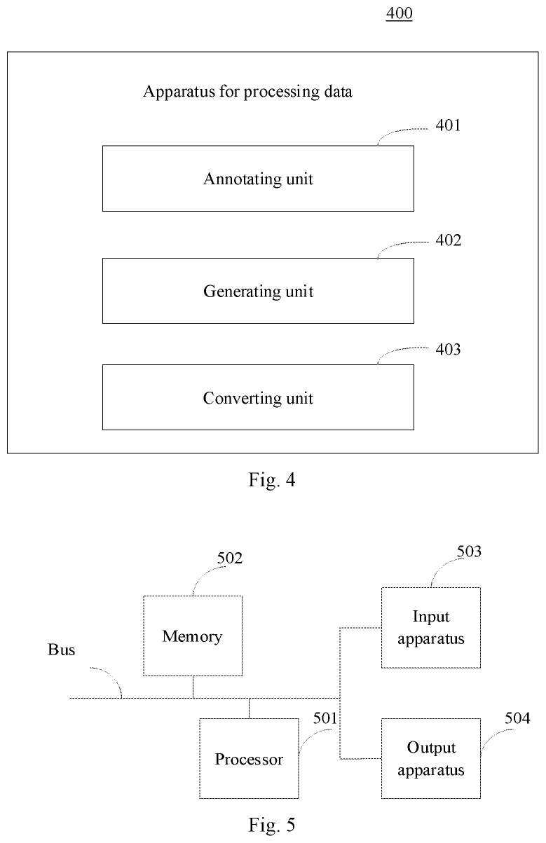

Further referring to FIG. 4, as an implementation of the method shown in FIGS. 1-3, the present disclosure provides an embodiment of an apparatus for processing data. The embodiment of the apparatus corresponds to the embodiment of the method shown in FIG. 1. The apparatus may be applied in various electronic devices.

As shown in FIG. 4, the apparatus 400 for processing data in this embodiment includes: an annotating unit 401, a generating unit 402 and a converting unit 403. Here, the annotating unit is configured to annotate, in response to receiving a page image, the page image to generate image sets corresponding to annotated data. Here, the image sets include a first image set for recognizing a container type, a second image set for recognizing text information, and a third image set for detecting an image element. The page image is generated based on a page template. The generating unit is configured to input the image sets into a trained image recognition model to generate a container type data set corresponding to the first image set, a text data set corresponding to the second image set and an image element data set corresponding to the third image set. Here, the image recognition model is used to represent a container type determination for each image in the first image set, a word detection and text recognition for each image in the second image set and an image element detection and recognition for each image in the third image set. The converting unit is configured to perform a conversion on the container type data set, the text data set and the image element data set based on template information of a page to generate a template data set corresponding to the page image, and upload the template data set. Here, the conversion is performed on the container type data set, the text data set and the image element data set based on a specific language structure.

In this embodiment, for specific processes of the annotating unit 401, the generating unit 402 and the converting unit 403 in the apparatus 400 for processing data, and their technical effects, reference may be respectively made to the related descriptions of steps 101-103 in the embodiment corresponding to FIG. 1, and thus, the details will not be repeatedly described here.

In some alternative implementations of this embodiment, the annotating unit includes: an annotating module, configured to annotate the page image to obtain the annotated data corresponding to the page image; a position generating module, configured to input the annotated data into a position determination model to generate position information of each block corresponding to the annotated data, where the position determination model is trained and obtained through historical related data of the annotated data; and a determining module, configured to determine the image sets corresponding to the annotated data based on the position information of each block.

In some alternative implementations of this embodiment, the image recognition model in the generating unit is trained and obtained using: an acquiring module, configured to acquire a training sample set, where a training sample in the training sample set includes the first image set for recognizing the container type, the second image set for recognizing the text information, the third image set for detecting the image element, the container type data set corresponding to the first image set, the text data set corresponding to the second image set and the image element data set corresponding to the third image set; and a training module, configured to use a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data.

In some alternative implementations of this embodiment, the image recognition model in the generating unit includes a container type recognition sub-model, a text recognition sub-model and an element recognition sub-model. The generating unit includes: a first generating module, configured to input the first image set into the container type recognition sub-model to generate the container type data set corresponding to the first image set, where the container type recognition sub-model is used to represent the container type determination for the each image in the first image set; a second generating module, configured to input the second image set into the text recognition sub-model to generate the text data set corresponding to the second image set, where the text recognition sub-model is used to represent the word detection and text recognition for the each image in the second image set; and a third generating module, configured to input the third image set into the element recognition sub-model to generate the image element data set corresponding to the third image set, where the element recognition sub-model is used to represent the image element detection and recognition for the each image in the third image set.

In some alternative implementations of this embodiment, the text recognition sub-model in the second generating module includes a feature extraction sub-model and a word sequence extraction sub-model. The second generating module includes: a feature extraction sub-module, configured to input the second image set into the feature extraction sub-model to obtain each feature matrix corresponding to the second image set, where the feature extraction sub-model is constructed based on a convolutional neural network; a word extraction sub-module, configured to input each feature matrix into the word sequence extraction sub-model to obtain a word sequence corresponding to the each feature matrix, where the word sequence extraction sub-model is constructed based on a recursive neural network; and a determining sub-module, configured to determine, based on each word sequence, text information corresponding to each word sequence, and generate the text data set corresponding to each piece of text information.

In some alternative implementations of this embodiment, the image recognition model in the generating unit is constructed based on a deep residual network model, and/or the container type recognition sub-model in the generating unit is constructed based on a deep residual network model.

In some alternative implementations of this embodiment, the apparatus further includes: a correcting unit, configured to perform a correction on the container type data set, the text data set and the image element data set to obtain corrected container type data set, corrected text data set and corrected image element data set, where the correction is used to represent reordering data in the container type data set, the text data set and the image element data set based on an analysis result of an image position, image order and image repeatability of each image in the image sets.

In some alternative implementations of this embodiment, the correction in the correcting unit is accomplished based on a combination of image scaling, image graying, an image enhancement, an image noise reduction and an image edge detection on the each image in the image sets.

In some alternative implementations of this embodiment, the apparatus further includes: a recognizing unit, configured to perform content recognition on the image sets to obtain a first data set corresponding to the first image set, a second data set corresponding to the second image set and a third data set corresponding to the third image set; and a revising unit, configured to perform a revision on the data in the container type data set, the text data set and the image element data set according to a comparison result of the first data set, the second data set and the third data set with the container type data set, the text data set and the image element data set, to obtain revised container type data set, revised text data set and revised image element data set after the revision.

In some alternative implementations of this embodiment, the apparatus further includes: a presenting unit, configured to generate a template interface corresponding to the template data set based on the template data set, and present the template interface; and/or an optimizing unit, configured to optimize a design scheme of the page template based on the template data set.

According to an embodiment of the present disclosure, the present disclosure further provides an electronic device and a readable storage medium.

As shown in FIG. 5, FIG. 5 is a block diagram of an electronic device of the method for processing data according to embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 5, the electronic device includes: one or more processors 501, a memory 502, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 5, one processor 501 is used as an example.

The memory 502 is a non-transitory computer readable storage medium provided by the present disclosure. The memory stores instructions executable by at least one processor, so that the at least one processor performs the method for processing data provided by the present disclosure. The non-transitory computer readable storage medium of the present disclosure stores computer instructions for causing a computer to perform the method for processing data provided by the present disclosure.

The memory 502, as a non-transitory computer readable storage medium, may be used to store non-transitory software programs, non-transitory computer executable programs and modules, such as program instructions/modules corresponding to the method for processing data in the embodiments of the present disclosure (for example, the annotating unit 401, the generating unit 402, and the converting unit 403 shown in FIG. 4). The processor 501 executes the non-transitory software programs, instructions, and modules stored in the memory 502 to execute various functional applications and data processing of the server, that is, to implement the method for processing data in the foregoing method embodiment.

The memory 502 may include a storage program area and a storage data area, where the storage program area may store an operating system and at least one function required application program; and the storage data area may store data created by the use of the electronic device according to the method for processing data, etc. In addition, the memory 502 may include a high-speed random access memory, and may also include a non-transitory memory, such as at least one magnetic disk storage device, a flash memory device, or other non-transitory solid-state storage devices. In some embodiments, the memory 502 may optionally include memories remotely provided with respect to the processor 501, and these remote memories may be connected to the electronic device of the method for processing data through a network. Examples of the above network include but are not limited to the Internet, intranet, local area network, mobile communication network, and combinations thereof.

The electronic device of the method for processing data may further include: an input apparatus 503 and an output apparatus 504. The processor 501, the memory 502, the input apparatus 503, and the output apparatus 504 may be connected through a bus or in other methods. In FIG. 5, connection through a bus is used as an example.

The input apparatus 503 may receive input digital or character information, and generate key signal inputs related to user settings and function control of the electronic device of the method for processing data, such as touch screen, keypad, mouse, trackpad, touchpad, pointing stick, one or more mouse buttons, trackball, joystick and other input apparatuses. The output apparatus 504 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

According to the technical solution of the embodiments of the present disclosure, in response to receiving a page image, the page image is annotated to generate image sets corresponding to annotated data. The image sets are inputted into a trained image recognition model to generate a container type data set corresponding to a first image set, a text data set corresponding to a second image set and an image element data set corresponding to a third image set. Here, the image recognition model is used to represent a container type determination for each image in the first image set, a word detection and text recognition for each image in the second image set and an image element detection and recognition for each image in the third image set. A conversion is performed on the container type data set, the text data set and the image element data set based on template information of a page to generate a template data set corresponding to the page image, and the template data set is uploaded. The page image is converted into template data by using the image recognition technology, and the template data is stored into a content distribution network by uploading the data, thereby avoiding the linear increment of the number of files due to the increasing demands for templates, and addressing the problems of poor reusability of JSON files in the existing technology and high maintenance cost during the building of pages. Accordingly, the precise positioning of the template data and the high efficiency in making the template on line are implemented, and both hands of a maintenance person are freed. The template data set is directly generated through the image recognition technology, which saves the development resources and maintenance cost of the system, and improves the flexibility of building the template.

It should be understood that the various forms of processes shown above may be used to reorder, add, or delete steps. For example, the steps described in the present disclosure may be performed in parallel, sequentially, or in different orders. As long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

1. A method for processing data, comprising:
annotating, in response to receiving a page image, the page image to generate image sets corresponding to annotated data, wherein the image sets comprise a first image set for recognizing a container type, a second image set for recognizing text information, and a third image set for detecting an image element, and the page image is generated based on a page template;
inputting the image sets into a trained image recognition model to generate a container type data set corresponding to the first image set, a text data set corresponding to the second image set and an image element data set corresponding to the third image set, wherein the image recognition model is used to represent a container type determination for each image in the first image set, a word detection and text recognition for each image in the second image set and an image element detection and recognition for each image in the third image set; and
performing a conversion on the container type data set, the text data set and the image element data set based on template information of a page to generate a template data set corresponding to the page image, and uploading the template data set, wherein the conversion is performed on the container type data set, the text data set and the image element data set based on a specific language structure.

2. The method according to claim 1, wherein annotating the page image to generate the image sets corresponding to the annotated data comprises:
annotating the page image to obtain the annotated data corresponding to the page image;
inputting the annotated data into a position determination model to generate position information of each block corresponding to the annotated data, wherein the position determination model is trained and obtained through historical related data of the annotated data; and
determining the image sets corresponding to the annotated data based on the position information of each block.

3. The method according to claim 1, wherein the image recognition model is trained and obtained by:
acquiring a training sample set, wherein a training sample in the training sample set comprises the first image set for recognizing the container type, the second image set for recognizing the text information, the third image set for detecting the image element, the container type data set corresponding to the first image set, the text data set corresponding to the second image set and the image element data set corresponding to the third image set; and
using a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data.

4. The method according to claim 1, wherein the image recognition model comprises a container type recognition sub-model, a text recognition sub-model and an element recognition sub-model, and inputting the image sets into the trained image recognition model to generate the container type data set corresponding to the first image set, the text data set corresponding to the second image set and the image element data set corresponding to the third image set comprises:
inputting the first image set into the container type recognition sub-model to generate the container type data set corresponding to the first image set, wherein the container type recognition sub-model is used to represent the container type determination for each image in the first image set;
inputting the second image set into the text recognition sub-model to generate the text data set corresponding to the second image set, wherein the text recognition sub-model is used to represent the word detection and text recognition for each image in the second image set; and
inputting the third image set into the element recognition sub-model to generate the image element data set corresponding to the third image set, wherein the element recognition sub-model is used to represent the image element detection and recognition for each image in the third image set.

5. The method according to claim 4, wherein the text recognition sub-model comprises a feature extraction sub-model and a word sequence extraction sub-model, and inputting the second image set into the text recognition sub-model to generate the text data set corresponding to the second image set comprises:
inputting the second image set into the feature extraction sub-model to obtain each feature matrix corresponding to the second image set, wherein the feature extraction sub-model is constructed based on a convolutional neural network;
inputting each feature matrix into the word sequence extraction sub-model to obtain a word sequence corresponding to each feature matrix, wherein the word sequence extraction sub-model is constructed based on a recursive neural network; and
determining, based on each word sequence, text information corresponding to each word sequence, and generating the text data set corresponding to each piece of text information.

6. The method according to claim 4, wherein the image recognition model is constructed based on a deep residual network model, and/or the container type recognition sub-model is constructed based on the deep residual network model.

7. The method according to claim 1, wherein, before performing the conversion on the container type data set, the text data set and the image element data set based on template information of the page to generate the template data set corresponding to the page image, the method further comprises:
performing a correction on the container type data set, the text data set and the image element data set to obtain corrected container type data set, corrected text data set and corrected image element data set, wherein the correction is used to represent reordering data in the container type data set, the text data set and the image element data set based on an analysis result of an image position, image order and image repeatability of each image in the image sets.

8. The method according to claim 7, wherein the correction is accomplished based on a combination of image scaling, image graying, an image enhancement, an image noise reduction and an image edge detection on each image in the image sets.

9. The method according to claim 7, wherein, before performing the correction on the container type data set, the text data set and the image element data set to obtain the corrected container type data set, the corrected text data set and the corrected image element data set, the method further comprises:
performing content recognition on the image sets to obtain a first data set corresponding to the first image set, a second data set corresponding to the second image set and a third data set corresponding to the third image set; and
performing a revision on the data in the container type data set, the text data set and the image element data set according to a comparison result of the first data set, the second data set and the third data set with the container type data set, the text data set and the image element data set, to obtain revised container type data set, revised text data set and revised image element data set.

10. The method according to claim 1, further comprising:
generating a template interface corresponding to the template data set based on the template data set, and presenting the template interface; and/or
optimizing a design scheme of the page template based on the template data set.

11. An apparatus for processing data, comprising:
at least one processor; and
a memory, in communication with the at least one processor,
wherein the memory stores instructions executable by the at least one processor, and the instructions when executed by the at least one processor, cause the at least one processor to perform operations, comprising:
annotating, in response to receiving a page image, the page image to generate image sets corresponding to annotated data, wherein the image sets comprise a first image set for recognizing a container type, a second image set for recognizing text information, and a third image set for detecting an image element, and the page image is generated based on a page template;
inputting the image sets into a trained image recognition model to generate a container type data set corresponding to the first image set, a text data set corresponding to the second image set and an image element data set corresponding to the third image set, wherein the image recognition model is used to represent a container type determination for each image in the first image set, a word detection and text recognition for each image in the second image set and an image element detection and recognition for each image in the third image set; and
performing a conversion on the container type data set, the text data set and the image element data set based on template information of a page to generate a template data set corresponding to the page image, and upload the template data set, wherein the conversion is performed on the container type data set, the text data set and the image element data set based on a specific language structure.

12. The apparatus according to claim 11, wherein annotating the page image to generate the image sets corresponding to the annotated data comprises:
annotating the page image to obtain the annotated data corresponding to the page image;
inputting the annotated data into a position determination model to generate position information of each block corresponding to the annotated data, wherein the position determination model is trained and obtained through historical related data of the annotated data; and
determining the image sets corresponding to the annotated data based on the position information of each block.

13. The apparatus according to claim 11, wherein the image recognition model in the generating unit is trained and obtained by:
acquiring a training sample set, wherein a training sample in the training sample set comprises the first image set for recognizing the container type, the second image set for recognizing the text information, the third image set for detecting the image element, the container type data set corresponding to the first image set, the text data set corresponding to the second image set and the image element data set corresponding to the third image set; and
using a deep learning method to train and obtain the image recognition model with the first image set, the second image set and the third image set that are included in training sample in the training sample set as input data and the container type data set corresponding to the first image set, the text data set corresponding to the second image set and the image element data set corresponding to the third image set as expected output data.

14. The apparatus according to claim 11, wherein the image recognition model in the generating unit comprises a container type recognition sub-model, a text recognition sub-model and an element recognition sub-model, and inputting the image sets into the trained image recognition model to generate the container type data set corresponding to the first image set, the text data set corresponding to the second image set and the image element data set corresponding to the third image set comprises:
inputting the first image set into the container type recognition sub-model to generate the container type data set corresponding to the first image set, wherein the container type recognition sub-model is used to represent the container type determination for each image in the first image set;
inputting the second image set into the text recognition sub-model to generate the text data set corresponding to the second image set, wherein the text recognition sub-model is used to represent the word detection and text recognition for each image in the second image set; and
inputting the third image set into the element recognition sub-model to generate the image element data set corresponding to the third image set, wherein the element recognition sub-model is used to represent the image element detection and recognition for each image in the third image set.

15. The apparatus according to claim 14, wherein the text recognition sub-model in the second generating module comprises a feature extraction sub-model and a word sequence extraction sub-model, and inputting the second image set into the text recognition sub-model to generate the text data set corresponding to the second image set comprises:
inputting the second image set into the feature extraction sub-model to obtain each feature matrix corresponding to the second image set, wherein the feature extraction sub-model is constructed based on a convolutional neural network;
inputting each feature matrix into the word sequence extraction sub-model to obtain a word sequence corresponding to each feature matrix, wherein the word sequence extraction sub-model is constructed based on a recursive neural network; and
determining, based on each word sequence, text information corresponding to each word sequence, and generate the text data set corresponding to each piece of text information.

16. (canceled)

17. The apparatus according to claim 11, wherein, before performing the conversion on the container type data set, the text data set and the image element data set based on template information of the page to generate the template data set corresponding to the page image, the method further comprises:
performing a correction on the container type data set, the text data set and the image element data set to obtain corrected container type data set, corrected text data set and corrected image element data set, wherein the correction is used to represent reordering data in the container type data set, the text data set and the image element data set based on an analysis result of an image position, image order and image repeatability of each image in the image sets.

18. The apparatus according to claim 17, wherein the correction is accomplished based on a combination of image scaling, image graying, an image enhancement, an image noise reduction and an image edge detection on each image in the image sets.

19. The apparatus according to claim 17, wherein, before performing the correction on the container type data set, the text data set and the image element data set to obtain the corrected container type data set, the corrected text data set and the corrected image element data set, the method further comprises:
performing content recognition on the image sets to obtain a first data set corresponding to the first image set, a second data set corresponding to the second image set and a third data set corresponding to the third image set; and
performing a revision on the data in the container type data set, the text data set and the image element data set according to a comparison result of the first data set, the second data set and the third data set with the container type data set, the text data set and the image element data set, to obtain revised container type data set, revised text data set and revised image element data set.

20. The apparatus according to claim 11, wherein the operations further comprise:
generating a template interface corresponding to the template data set based on the template data set, and present the template interface; and/or
optimizing a design scheme of the page template based on the template data set.

21. (canceled)

22. A non-transitory computer readable storage medium, storing a computer instruction, wherein the computer instruction, when executed by a processor, causes the processor to perform operations, comprising:
annotating, in response to receiving a page image, the page image to generate image sets corresponding to annotated data, wherein the image sets comprise a first image set for recognizing a container type, a second image set for recognizing text information, and a third image set for detecting an image element, and the page image is generated based on a page template;
inputting the image sets into a trained image recognition model to generate a container type data set corresponding to the first image set, a text data set corresponding to the second image set and an image element data set corresponding to the third image set, wherein the image recognition model is used to represent a container type determination for each image in the first image set, a word detection and text recognition for each image in the second image set and an image element detection and recognition for each image in the third image set; and
performing a conversion on the container type data set, the text data set and the image element data set based on template information of a page to generate a template data set corresponding to the page image, and upload the template data set, wherein the conversion is performed on the container type data set, the text data set and the image element data set based on a specific language structure.
